(19) United States
(12) Patent Application Publication
(10) Pub. No.: US 2024/0032109 A1
(43) Pub. Date: Jan. 25, 2024

(54) RANDOM ACCESS CHANNEL OCCASION WITH MULTIPLE BEAMS

(71) Applicant: Nokia Technologies Oy, Espoo (FI)

(72) Inventors: Michal MATERNIA, Wroclaw (PL); Axel MUELLER, Massy (FR); Matha DEGHEL, Massy (FR); Anupam SHRIVASTAVA, Dallas, TX (US); Ian Dexter GARCIA, Naperville, IL (US); Arto LEHTI, Massy (FR); Cássio Barboza RIBEIRO, Espoo (FI); Alessio MARCONE, Munich (DE); Marco MASO, Massy (FR)

(21) Appl. No.: 18/354,390

(22) Filed: Jul. 18, 2023

(30) Foreign Application Priority Data
Jul. 22, 2022 (GB) 2210761.9

(51) Int. Cl. H04W 74/08; H04W 74/00

(52) U.S. Cl. CPC H04W 74/0833; H04W 74/006

(57) ABSTRACT

Systems, methods, apparatuses, and computer program products for enabling multi-beam PRACH. One method may include transmitting a physical random access channel preamble based upon at least two different transmission beams in the same random access channel occasion; and receive a message configured to indicate a preferred transmission beam of the transmission beams used with the physical random access channel preamble.

### TECHNICAL FIELD

Some example embodiments may generally relate to mobile or wireless telecommunication systems, such as Long Term Evolution (LTE), fifth generation (5G) radio access technology (RAT), new radio (NR) access technology, sixth generation (6G), and/or other communications systems. For example, certain example embodiments may relate to systems and/or methods for enabling multi-beam physical random access channel (PRACH).

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include transmitting, by a user equipment, a physical random access channel preamble based upon at least two different transmission beams in the same random access channel occasion. The method may further include receiving, by the user equipment, a message configured to indicate a preferred transmission beam of the transmission beams used with the physical random access channel preamble.

In accordance with certain example embodiments, an apparatus may include means for transmitting a physical random access channel preamble based upon at least two different transmission beams in the same random access channel occasion. The apparatus may further include means for receiving a message configured to indicate a preferred transmission beam of the transmission beams used with the physical random access channel preamble.

In accordance with various example embodiments, a non-transitory computer readable medium comprising program instructions that, when executed by an apparatus, cause the apparatus to perform at least a method. The method may include transmitting a physical random access channel preamble based upon at least two different transmission beams in the same random access channel occasion. The method may further include receiving a message configured to indicate a preferred transmission beam of the transmission beams used with the physical random access channel preamble.

In accordance with some example embodiments, a computer program product may perform a method. The method may include transmitting a physical random access channel preamble based upon at least two different transmission beams in the same random access channel occasion. The method may further include receiving a message configured to indicate a preferred transmission beam of the transmission beams used with the physical random access channel preamble.

In accordance with certain example embodiments, an apparatus may include at least one processor and at least one memory storing instructions that, when executed by the at least one processor, cause the apparatus at least to transmit a physical random access channel preamble based upon at least two different transmission beams in the same random access channel occasion. The at least one memory and instructions, when executed by the at least one processor, may further cause the apparatus at least to receive a message configured to indicate a preferred transmission beam of the transmission beams used with the physical random access channel preamble.

In accordance with various example embodiments, an apparatus may include circuitry configured to transmit a physical random access channel preamble based upon at least two different transmission beams in the same random access channel occasion. The circuitry may further be configured to receive a message configured to indicate a preferred transmission beam of the transmission beams used with the physical random access channel preamble.

In accordance with some example embodiments, a method may include receiving, by a network entity, a physical random access channel preamble based upon at least two different transmission beams in the same random access channel occasion from the same user equipment. The method may further include detecting, by the network entity, a transmission beam switching operation of the user equipment. The method may further include transmitting, by the network entity, a message configured to indicate a preferred transmission beam of the transmission beams used with the physical random access channel preamble.

In accordance with certain example embodiments, an apparatus may include means for receiving a physical random access channel preamble based upon at least two different transmission beams in the same random access channel occasion from the same user equipment. The apparatus may further include means for detecting a transmission beam switching operation of the user equipment. The apparatus may further include means for transmitting a message configured to indicate a preferred transmission beam of the transmission beams used with the physical random access channel preamble.

In accordance with various example embodiments, a non-transitory computer readable medium comprising program instructions that, when executed by an apparatus, cause the apparatus to perform at least a method. The method may include receiving a physical random access channel preamble based upon at least two different transmission beams in the same random access channel occasion from the same user equipment. The method may further include detecting a transmission beam switching operation of the user equipment. The method may further include transmitting a message configured to indicate a preferred transmission beam of the transmission beams used with the physical random access channel preamble.

In accordance with some example embodiments, a computer program product may perform a method. The method may include receiving a physical random access channel preamble based upon at least two different transmission beams in the same random access channel occasion from the same user equipment. The method may further include detecting a transmission beam switching operation of the user equipment. The method may further include transmitting a message configured to indicate a preferred transmission beam of the transmission beams used with the physical random access channel preamble.

In accordance with certain example embodiments, an apparatus may include at least one processor and at least one memory storing instructions that, when executed by the at least one processor, cause the apparatus at least to receive a physical random access channel preamble based upon at least two different transmission beams in the same random access channel occasion from the same user equipment. The at least one memory and instructions, when executed by the at least one processor, may further cause the apparatus at least to detect a transmission beam switching operation of the user equipment. The at least one memory and instructions, when executed by the at least one processor, may further cause the apparatus at least to transmit a message configured to indicate a preferred transmission beam of the transmission beams used with the physical random access channel preamble.

In accordance with various example embodiments, an apparatus may include circuitry configured to receive a physical random access channel preamble based upon at least two different transmission beams in the same random access channel occasion from the same user equipment. The circuitry may further be configured to detect a transmission beam switching operation of the user equipment. The circuitry may further be configured to transmit a message configured to indicate a preferred transmission beam of the transmission beams used with the physical random access channel preamble.

### BRIEF DESCRIPTION OF THE DRAWINGS

For a proper understanding of example embodiments, reference should be made to the accompanying drawings, wherein:

FIG. 1 illustrates an example of an initial beam pair link establishment during random access (RA).

FIG. 2 illustrates an example of an association between random access channel occasion (RO) to synchronization signal block (SSB).

FIG. 3 illustrates an example of RA configurations for frequency range (FR)1 and unpaired spectrum, as in existing 3GPP specification TS 38.211.

FIG. 4 illustrates an example of a medium access control (MAC) protocol data unit (PDU), as in existing 3GPP specification TS 38.321.

FIG. 5 illustrates an example of a MAC subheader including random access preamble identifier (RAPID), as in existing 3GPP specification TS 38.321.

FIG. 6 illustrates an example of a MAC random access response (RAR), as in existing 3GPP specification TS 38.321.

FIG. 7 illustrates an example of an uplink (UL) grant, as in existing 3GPP specification TS 38.213.

FIG. 8 illustrates an example of a signaling diagram according to certain example embodiments.

FIG. 9 illustrates an example of user equipment (UE) message (Msg1) transmission (Tx) beam switching within RO boundaries of a random access channel (RACH) format with sequence repetition.

FIG. 10 illustrates an example of changing a UE Tx beam during a PRACH preamble (i.e., Msg1) transmission during a single RO.

FIG. 11 illustrates an example of a UE Tx beam change during PRACH preamble transmission during a single RO.

FIG. 12 illustrates an example of implicit sharing of cyclic prefix (CP) via beam switch sample timing.

FIG. 13 illustrates an example of a flow diagram of a method according to various example embodiments.

FIG. 14 illustrates another example of a flow diagram of a method according to various example embodiments.

FIG. 15 illustrates another example of a flow diagram of a method according to various example embodiments.

FIG. 16 illustrates another example of a flow diagram of a method according to various example embodiments.

FIG. 17 illustrates an example for coherent combination length=2 and correlation receivers using RACH format A2.

FIG. 18 illustrates another example for coherent combination length=2 and correlation receivers using RACH format A2.

FIG. 19 illustrates a flow diagram of a simple “best beam” selector implementation based on/re-utilizing a coherent combination length correlation detector implementation.

FIG. 20 illustrates an example of various network devices according to some example embodiments.

FIG. 21 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for enabling multi-beam PRACH is not intended to limit the scope of certain example embodiments, but is instead representative of selected example embodiments.

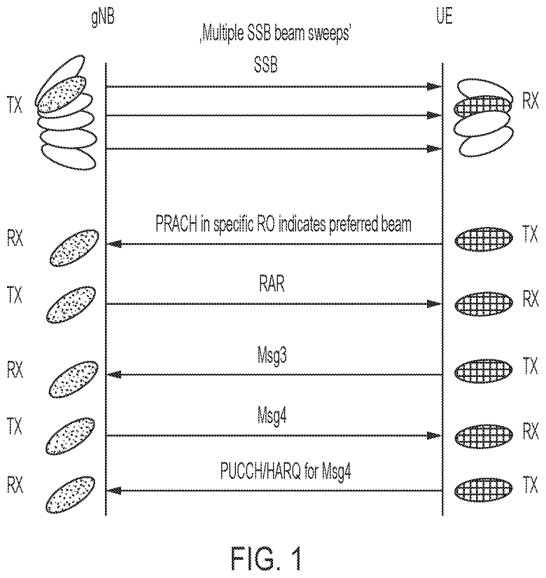

In order to establish an initial beam pair link during a RA procedure in beamformed deployments (which may not be limited to FR2/mmW and FR1/cmw, but to systems operating in other frequencies as well), a UE may need to transmit a preamble in a RO associated with a certain SSB index. As shown in FIG. 1, during RA, the UE may use the same Tx beam as used for PRACH preamble transmission in certain ROs, and the same Rx beam that was used for SSB detection. Similarly, the base station may use the same Rx beam used to detect the PRACH preamble in a certain RO, and the same Tx beam used for transmission of a certain SSB. Furthermore, some FR2 UE Rx beams may be significantly obstructed; thus, before selecting a suitable RO for preamble transmission, the UE may test different Rx beams. For example, if the UE has 2 Rx beams, the first Rx beam may be used for SSB measurement during a first SSB period, while the second Rx beam may be used for SSB measurements during a second SSB period.

Regarding the relationship between ROs, SSBs, and preambles, a RO may refer to a resource specified in time and frequency domain that is available to transmit RACH preambles. In 3GPP NR, SSB indices may be associated with ROs via higher-layer signaling. In order to accommodate various network deployments and loads, mapping between SSBs and ROs may be very flexible, and may be defined by two parameters: Ssb-perRACH-OccasionAndCB-PreamblePerSSB and msg1-FDM . Specifically, Ssb-perRACH-OccasionAndCB-PreamblePerSSB may refer to a number of SSBs mapped to a single RO, and the number of preamble indices associated with a single SSB. Similarly, msg1-FDM may refer to the number of ROs in frequency domain.

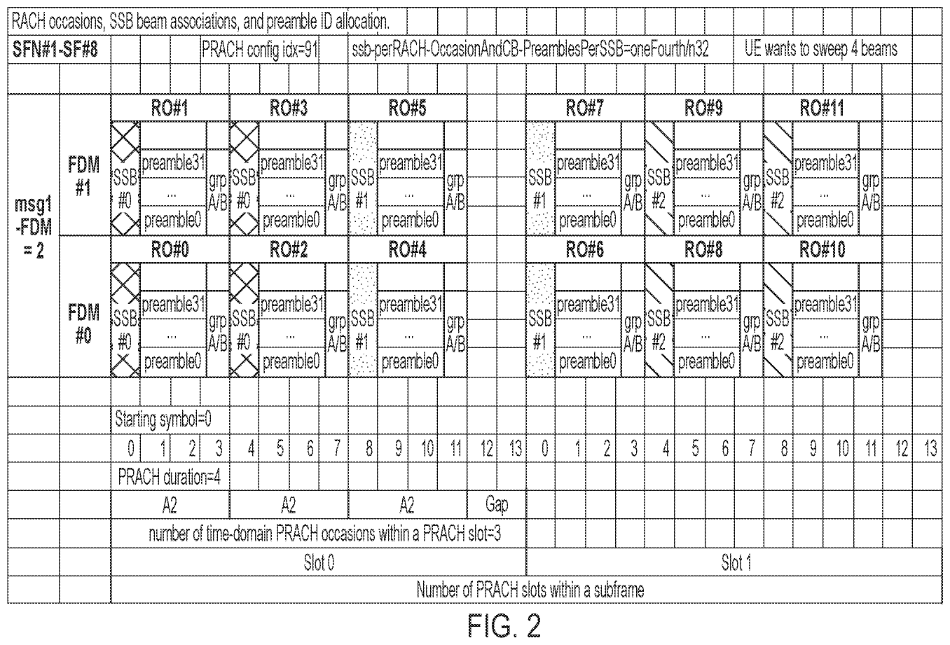

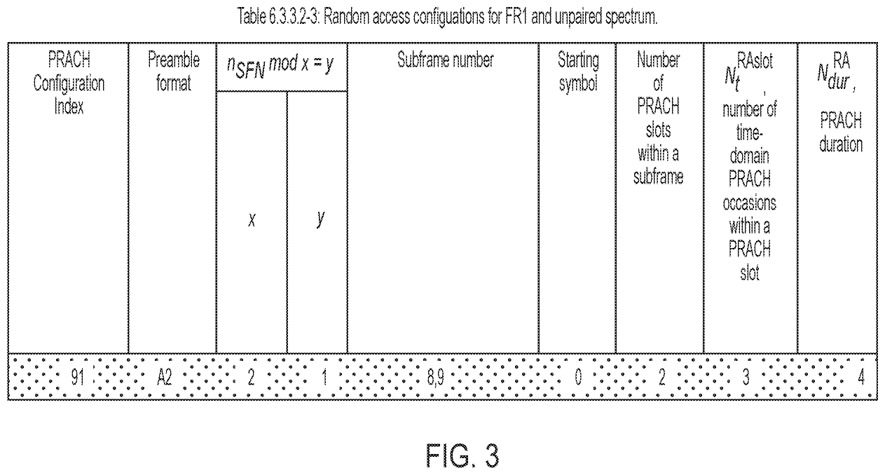

Regardless of how the mapping between SSBs and ROs is configured, upon receiving the cell-specific RACH configuration, each UE may know which preamble can be selected for transmission in which RO when the SSB has been selected. The base station may then perform preamble reception and detection, with no ambiguity in the SSB/RO domain, such as outside of preamble collision. FIG. 2 illustrates an example of a relationship between SSB and RO. Using index 91 shown in FIG. 3, the PRACH configuration may include msg1-FDM=2 and ssb-perRACH-OccasionAndCB-PreamblesPerSSB=oneFourth/n32.

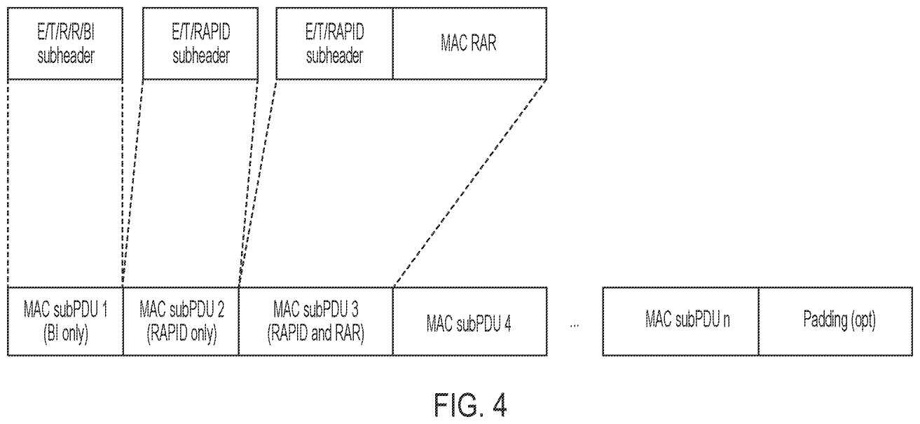

Msg2 is transmitted in downlink (DL) during the RA procedure, whereby the base station transmits to the UE information for configuring and transmitting Msg3 over the physical uplink shared channel (PUSCH). Msg2 typically includes a MAC protocol data unit (PDU), which itself may include one or more MAC subPDUs. When the size of the MAC PDU does not coincide with a valid transport block size (TBS) value (resulting from the number of resources scheduled by the base station for transmitting Msg2), a padding may be added at the end of the MAC PDU. In this way, the presence and length of a padding may be implicit based on both TBS and the size of the MAC subPDUs. In general, each MAC subPDU may include a MAC subheader with only a backoff indicator, only a RAPID field in the subheader (thus, an acknowledgement for system information (SI) request), or a RAPID and MAC RAR. Different combinations of the subPDU instances may occur in a MAC PDU, as shown in FIG. 4.

Alternatively, at least one MAC subheader with RAPID and MAC RAR may be included in the MAC PDU during access for the UE to configure and perform Msg3 transmissions. MAC PDUs with RAPID and MAC RAR may be included anywhere between the MAC subPDU with only a backoff indicator (if any) and padding (if any).

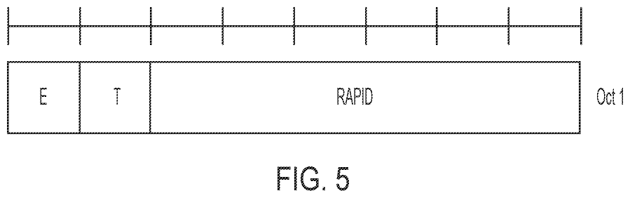

FIG. 5 depicts a MAC subheader with RAPID that may include header fields E, T, and RAPID. Specifically, E may correspond with an extension field, such as a flag indicating whether the MAC subPDU, including this MAC subheader, is the last MAC subPDU in the MAC PDU. This field may be set to “0,” indicating that the MAC subPDU, including this MAC subheader, is the last MAC subPDU in the MAC PDU; otherwise, this field may be set to “1.” T may correspond with a type field, such as a flag indicating whether the MAC subheader contains a random access preamble ID or a backoff indicator. The T field may be set to “1” to indicate the presence of a RAPID field in the subheader; otherwise, this field may be set to “0.” Furthermore, the RAPID field may identify the transmitted random access preamble, which may have a size of 6 bits.

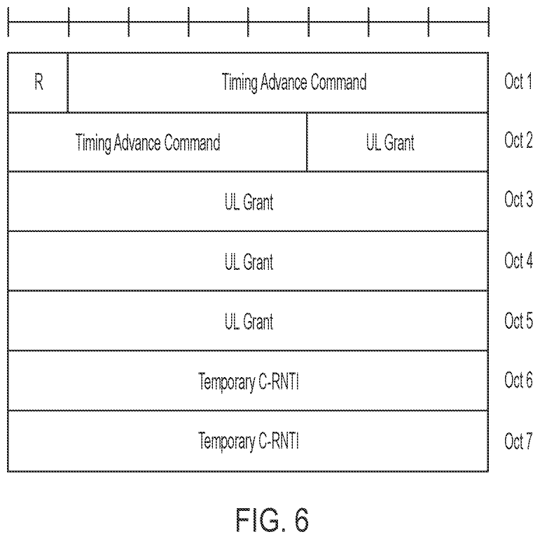

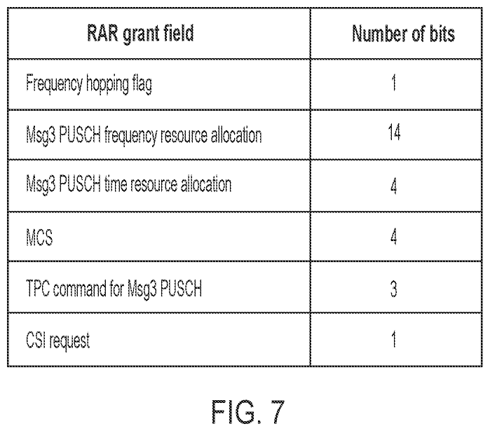

FIG. 6 depicts a MAC RAR of a fixed size, and may have fields including any of R, timing advance command, UL grant, and temporary cell radio network temporary identifier (C-RNTI). R may be a reserved bit, set to “0”; timing advance command is a 12-bit field indicating the index value timing advance (TA) used to control the amount of timing adjustment that the UE must apply for UL frame transmission. As shown in FIG. 7, a UL grant may be a 27-bit field indicating the resources to be used on the uplink (whose content is described above with respect to FIG. 5), wherein a channel state information (CSI) request is a reserved bit during contention based random access (CBRA); and temporary C-RNTI may be a 16-bit field indicating the temporary identity which the UE should use for scrambling the cyclic redundancy check (CRC) of the Msg3 transmitted over the resources scheduled by the UL grant.

Each UE in radio resource control (RRC) CONNECTED mode may require a successful RA procedure to be considered within a given cell range. Successful detection of UL messages exchanged during RA procedure, for example, Msg1 and Msg3, may define a cell range. The PRACH preamble, for example, Msg1 of RA procedure, as a sequence-based signal may have a larger link budget than the PUSCH-based Msg3 transmission. Msg3 may be a critical message when determining cell range; thus, appropriate selection of UE Tx beam for Msg3 may be important. As used throughout this disclosure, UE Tx beam may include any possible spatial transmission filter or method that achieves steerable, spatial “volumes” signal gains. This may also include the use of different UE Tx panels; each panel may represent one or more beams.

In beamformed deployments, in addition to UE Tx power, UE Tx beam selection may also determine the UL link budget. However, UE Tx beam selection for transmission of PRACH preambles in a specific RO may have some disadvantages. For example, the UE may not be expected to select the best SSB index and corresponding RO/UE Tx beam for PRACH preamble transmission. The UE may choose a SSB index/beam above a measured SSB power threshold, such as rsrp-ThresholdSSB. The Rx beam used for this SSB measurement may not be the best one; in case this threshold is not met, the UE may select any SSB. Similarly, UE Tx beam selection based on UE Rx beam measurements may not be optimal due to, for example, different characteristics of amplifiers used for transmission and reception (e.g., low noise amplifier vs power amplifier); different physical phase shifter implementation for DL receiving and UL transmission; separation of transmission and receive antennas to avoid switching time losses; difference in mutual coupling of antenna elements of multi-antenna hardware; angle of arrival different from angle of departure; frequency-response mismatch of transmitter and receiver filters; and/or Rx beam selection tolerance/error in case of low signal to interference & noise ratio (SINR) environment, specifically, a beam overlapping region. After performing the RA procedure, an optimal UE Tx beam may be determined using appropriate and known beam management procedures. However, the Msg3 may need to be transmitted before RRC_connected is reached, and before these beam management procedures become available. Thus, during RA, proper selection of a UE Tx beam for Msg3 may be important for good cell coverage, while Msg1 may outreach Msg3 coverage. As will be discussed below, some embodiments disclosed herein may improve or enable multi-beam PRACH.

Certain example embodiments described herein may have various benefits and/or advantages to overcome the disadvantages described above. For example, certain example embodiments may improve spatial diversity gain for legacy PRACH Msg1 transmission, such as where UE Tx beam selection based on UE Rx beam measurements may not be optimal, if UL/DL reciprocity does not hold or different/finer beams are used. In some example embodiments, the UE may attempt several UL Tx beams around an initial choice and (or refine the initial choice) to improve spatial diversity even for Msg1. In addition, the best beam may be chosen for Msg3 transmission, which increases Msg3 coverage and thus, increasing cell coverage.

Other multi-beam RA methods may have a problem on how the base station can detect that it is the same UE transmitting PRACH with multiple beams; some example embodiments discussed herein may resolve this disadvantage, as well as avoid solutions that cost RACH resources to make this distinction.

In various example embodiments, a change of UE transmission beam may be detected by the base station so it is not necessary to further complicate the random access configuration with UE-to-base station signaling or resource planning. In addition, the spatial diversity gain of Msg1 may increase the probability of Msg1 reception since it is unlikely that all tried beams are “bad,” and so the average number of UE Msg1 retries may be decreased. Along with the increased Msg3 coverage, the reduced number of Msg1 retries may further improve field accessibility key performance indicators (KPIs) such as “Attach time,” and “Service Request Time”. The reduced number of Msg1 retries may also improve handover related field and network KPIs such as “Handover Execution Time,” “Handover Service Interrupt Time”, “Handover failure success rate.”

Furthermore, UEs are currently explicitly forbidden from changing beams during RO. By changing this for new Tx beam changing UEs and detecting this behavior, the UE/RAPID that is a Tx beam changing UE may be detected. Hence, the current need to subdivide the RAPID sequence space to distinguish legacy and Tx beam changing UEs is no longer required, freeing preamble resources and reducing the RACH collisions in the cell, either from having more available RAPIDs or from avoiding non-beam changing UEs to randomly select RAPIDs pertaining to changing UEs.

In addition, the current schemes can be made partially similar to various example embodiments by halving the preamble configuration length, such as from A2 to A1, UEs using different Tx beams per shorter RO, and indicating the best beam by the base station via corresponding RA-radio network temporary identifier (RNTI). However, in order to avoid collision on the ROs between legacy UEs using a random RAPID and repetitions of transmissions of beam changing UEs, thereby keeping the same RAPID for all ROs to tell the base station that they are only on beam-changing UE, the expensive RAPID subdivision or generally RACH resource subdivision scheme may still be needed. If the Msg1 link budget is larger than the Msg3 link budget, some example embodiments may be advantageous over currently considered schemes in RAN1 since range is not compromised, and legacy vs beam changing UEs are reliably distinguished without RACH resource sub-division. If the link budget limitation is the Msg1, then certain example embodiments may double the preamble configuration length, such as from A2 to A3, to keep the same link budget for Msg1 as legacy. The RAPID subdivision saving is still valid, albeit the new solution loses its latency advantage. Thus, certain example embodiments discussed below are directed to improvements in computer-related technology.

In general, signaling other than Msg2 may be used to inform the UE about which beam to use for Msg3, and broadcast signaling other than SIB may be used to inform multi-Tx UE about an intra-RO beam change capable system, or trigger this mode of operation.

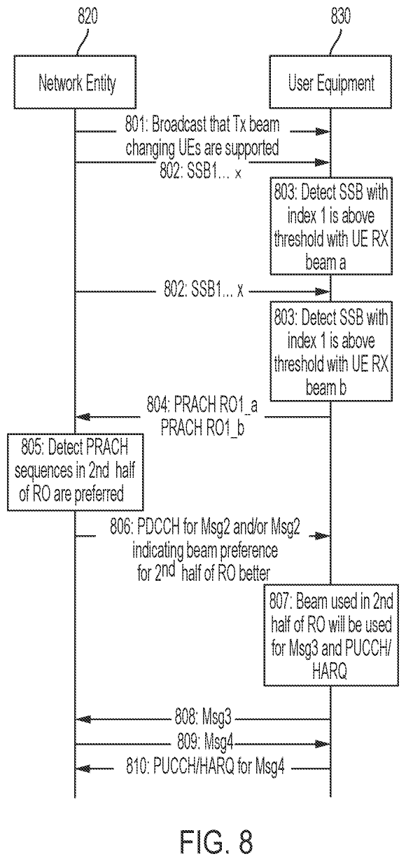

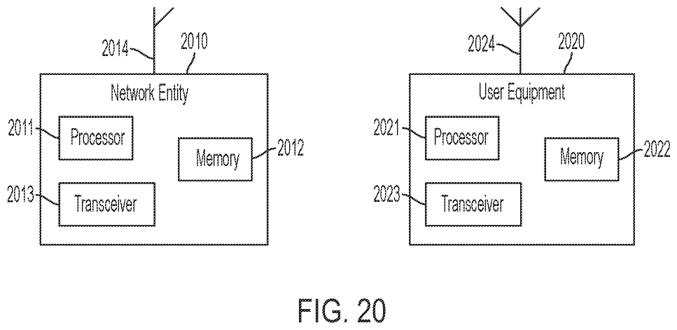

FIG. 8 illustrates an example of a signaling diagram depicting for enabling multi-beam PRACH. NE 820 and UE 830 may be similar to NE 2010 and UE 2020, as illustrated in FIG. 20, according to certain example embodiments. In general, UE Tx beam switching may be fully or partially non-aligned with RO boundaries, i.e., UE tx beam switching is not constrained to happen within only one RO.

Some example embodiments may assume that NE 820 can reliably detect the presence of a Tx sweeping non-legacy UE either by using coherent combination length correlation receiver peak comparison, or by being directly indicated by the UEs themselves. The direct indication methods may set restrictions to RA configuration, and hence, it is beneficial that they can be avoided, as they may be RACH-resource intensive.

At 801, NE 820 may broadcast information (alternatively, dedicated signaling) that Tx beam changing UEs are supported and requested or allowed or enabled to attempt up to [N] beams per RO. NE 820 may broadcast the information (alternatively, dedicated signaling) via any of master information block (MIB), system information block (SIB), and SI.

In some example embodiments, NE 820 may indicate to UE 830 beam-change mapping as part of system information, such as SIB, to control the beam switching points at UE 830. As an example, NE 820 may select a PRACH configuration index with format B4 characterized by 12 symbol-based back-to-back repetitions of the preamble sequence, and further indicate how many back-to-back repetitions out of the 12 repetitions should be used by a single UE beam. Thus, if NE 820 indicates 6 or 3 repetitions per beam, UE 830 may sweep through, respectively, 2 or 4 of its beams during preamble transmission. In this way, NE 820 may not need to detect when UE 830 is doing beam switching, which could be challenging when the correlation peak is close or below the noise floor for the single repetition.

At 802, NE 820 may transmit multiple SSB1 . . . x to UE 830. In addition, NE 820 may also broadcast beam-change mapping/time instances to UE 830.

At 803, UE 830 may detect that certain SSB indexes (which NE 820 may transmit using a certain gNB Tx beam) may be used for RA when it is measured by, for example, UE Rx beam_a and beam_b As shown in FIG. 8, UE 830 may detect an SSB with index 1 above a threshold with UE Rx beam a (received at 802), while also detecting an SSB with index 1 above a threshold with UE Tx beam b (received at 802). In this way, UE 830 may select RO associated with SSB with index 1 and use the two strongest Rx beams, along with their Tx equivalent, in a Msg1 beam change procedure (as discussed below). In some example embodiments, UE 830 may sweep different Tx beams during Msg1 without having measured different DL beams on repeating SSBs.

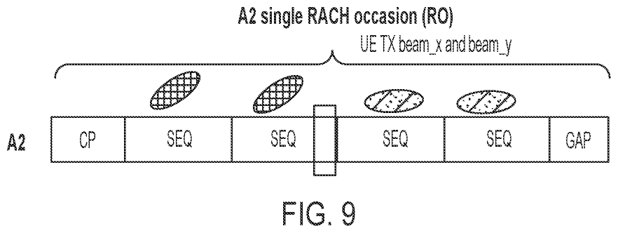

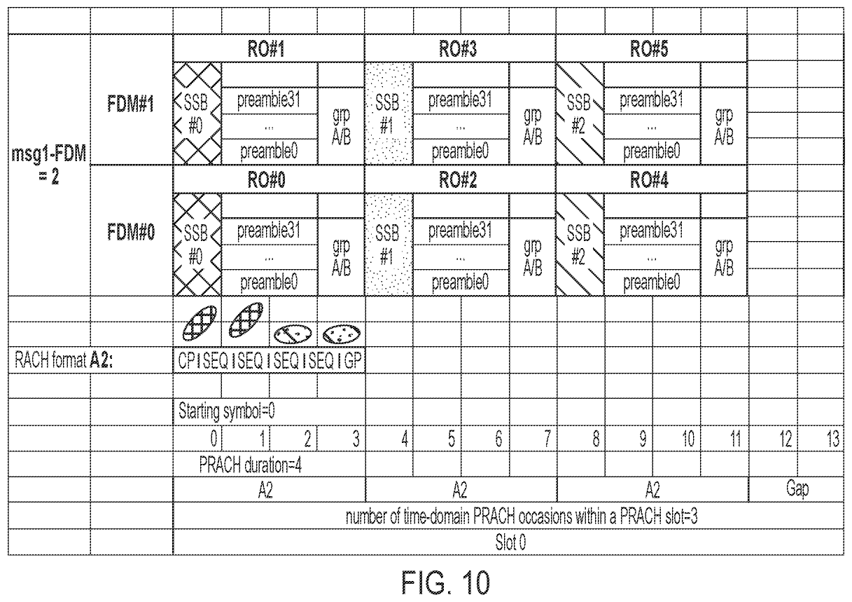

In 804, UE 830 may transmit to NE 820 a PRACH preamble, which may include repetitions of an original sequence, and use different Tx beams (or UL spatial filters) in the same RO, which may follow the beam change mapping from 801. In some example embodiments, and as illustrated in FIGS. 9 and 10, UE 830 may use beam_a for the first half of the RO, and beam_b for the second half of the RO. In some example embodiments, UE 830 may use different arrays in the UL and DL direction; as a result, UE 830 may not use the same beam weights, and instead may need to find beams that spatially correspond to each other in both directions. In addition, the switching point may not be after the second sequence repetition, but CP/nbrTxSweptBeams may be before the repetition, in order to generate a new CP that may absorb imperfections.

In various example embodiments, UE 830 may transmit to NE 820 a single Tx beam in all repetitions within the same RO if UE 830 determines that there are no other viable Tx beams. If UE 830 is a legacy UE, UE 830 may continue to transmit the PRACH preamble via a single Tx beam in the same RO. Thus, UE 830 may transmit both scenarios with backward compatibility. As a result, Tx beam changing UEs, such as UE 830, may be required to transmit on the first UE beam starting in the first sub-segment/sequence of the RO, thereby avoiding false alarms of non-changing legacy UEs that may only begin transmitting in later sequences (SEQs).

At 805, NE 820 may detect that PRACH sequences in the 2^{nd} half of the RO are preferred. For example, NE 820 may detect a UE Tx beam switching operation of UE 830, for example, by observing changes in the correlation receiver peaks of different sequentially shifted, coherent combination windows. As an example, NE 820 may use different coherent combining lengths for Msg1 sequence correlation receivers, such as by combining 2 sequence repetitions in scenarios with mobility. Since UE 830 may switch its Tx beam within the RO, and the same sequence/RAPID preamble is used, NE 820 may determine that both correlation peaks of this sequence pertain to UE 830 (rather than another interfering UE that may have transmitted Msg1 outside of the beginning of a RO), and that UE 830 is performing the Tx beam switching.

In various example embodiments, NE 820 may simultaneously support the detection of both single beam and multiple-beam ROs without additional indications from legacy UEs and non-legacy UEs. This distinction of legacy and intra-RO beam switching non-legacy UEs may be achieved by the aforementioned observing of changes in the correlation receiver peaks of different sequentially shifted, coherent combination windows. Non-legacy UEs may choose to use a single Tx beam for the RO if only a single beam is deemed to be viable. For UEs which use a single Tx beam, the Msg2 indication ‘best received’ preamble part' may be discarded, and the beam used for Msg1 may also be used for Msg3. Hence, some embodiments may be transparent to UEs which use a single Tx beam in all the repetitions within the single RO.

In various example embodiments, NE 820 may detect a single RO associated with the UE Tx beam providing the best quality, such as the UE Tx beam received with the highest power and results in the highest correlator peaks (e.g., beam_y). In various example embodiments, in order to support legacy UEs (and non-legacy UEs that choose not to use the 2^{nd} Tx beam), NE 820 may detect a single Tx beam used using none or any of the preamble repetitions. NE 820 may simultaneously support the detection of both single beam and multi-beam ROs without additional indications from legacy UEs and non-legacy UEs, which may instead use legacy preamble sequences.

It is noted that NE 820 may distinguish legacy (non-Tx beam changing) and new (Tx beam changing) UEs also using, for example, legacy and new UEs using different preamble/RAPID subsets, and/or by using the disclosed beam change detection algorithm to see if a certain UE/RAPID is switching the beam. Only non-legacy UEs may then be signaled which beam to use. Legacy UEs may not be able to decode the new modified Msg2 signaling and, thus, fail RA or ignore NE 820 beam preference and perform RA according to legacy procedure.

At 806, NE 820 may transmit to UE 830 a modified Msg2, which may indicate which part of the RO is received better or is preferred, informing UE 830 which UE Tx beam is better/preferred by NE 820. UE 830 may then proceed with the RA procedure using the beam indicated by NE 820, for example, by transmitting Msg3 with beam_b).

In certain example embodiments, NE 820 may indicate the best UE Tx beam (or UL spatial filter) to UE 830 using a MAC CE subPDU specified to be sent in Msg2/RAR that links RAPID to best switched beam. For example, an additional octet may be added to the end of the MAC RAR that indicates either the number of the tried beam, and/or an octet may be a bitmap corresponding to which beams are usable, such as the 1^{st} and 5^{th}. In certain example embodiments, NE 820 may indicate the best UE Tx beam using a reserved and/or existing bit in a MAC control element (CE) sent in Msg2. Furthermore, NE 820 may indicate the best UE Tx beam through DCI carried by physical downlink control channel (PDCCH) of Msg2; for example, an association to existing parameter entries may be used which are already indicated/carried in downlink control information (DCI), such as time domain resource allocation (TDRA) and modulation and coding scheme (MCS).

In various example embodiments, NE 820 may use any broadcast channel available before UE 830 is in connected mode to distribute the RO and RAPID used by the Tx beam, changing UE 830 along with the indication of which switching instance was the best, for example, SIB/SI signaling.

In some example embodiments, for UEs using legacy method, which are limited to a single beam in a single RO, and non-legacy UEs which used a single beam, the best preamble part indication of the gNB in Msg2 may be ignored. These UEs may transmit Msg3 using the Msg1 beam.

In certain example embodiments, based on outcome of preamble detection, NE 820 may infer that UE 830 is using legacy method, in which case the indication of best UE Tx beam will not be present in Msg2. Standard legacy RA procedure may then be used. For example, this could also be the case for a legacy NE that does not support the new RA procedure. In this case, UE 830 may transmit Msg3 using the Msg1 beam, for example.

At 807, UE 830 may designate the indicated beam for transmitting Msg3 to NE 820 and/or all other signals until RACH either succeeds or fails.

In various example embodiments, in order to provide a large cell coverage in beamformed deployments, e.g. in FR2/mmW, NE 820 may configure UE 830, such as with broadcast or dedicated signaling, with short PRACH preamble formats, for example, A3, B4, C2, that include multiple time domain repetitions of original sequence, such as all short formats except C0.

For short PRACH preambles, an original PRACH sequence may be repeated in time domain, where a number of repetitions depend on the PRACH format and desired cell range, among many other considerations. The repetition of original PRACH sequence may enable coherent combining of repeated signals. However, for short PRACH formats with a large number of repetitions used for large cell range, a number of repetitions used for coherent combining may be, by default, smaller than the total number of repetitions for a given format. For example, for PRACH format B4, that includes 12 repetitions of the original PRACH sequence, only 4 sequence repetitions (or less in the case of mobility) are used for coherent combining in state-of-the-art algorithms. Such approach renders gNB feasibility to detect which part of RO is better.

FIG. 9 depicts one example of how a beam switching window/CP* may be configured. As shown, beam switching may be applied for PRACH preamble format consisting of 4 sequence repetitions (e.g., A2 or B2).

Different Tx beam (beam_x) may be applied for the first 2 sequence repetitions, and another Tx beam (beam_y) may be applied for the last 2 sequence repetitions. FIG. 10 illustrates Tx beam switching in relation to a complete PRACH configuration (i.e., switching within an RO), while in contrast, Tx beam switching illustrated in FIG. 9 may be applied in RO corresponding to SSB #0.

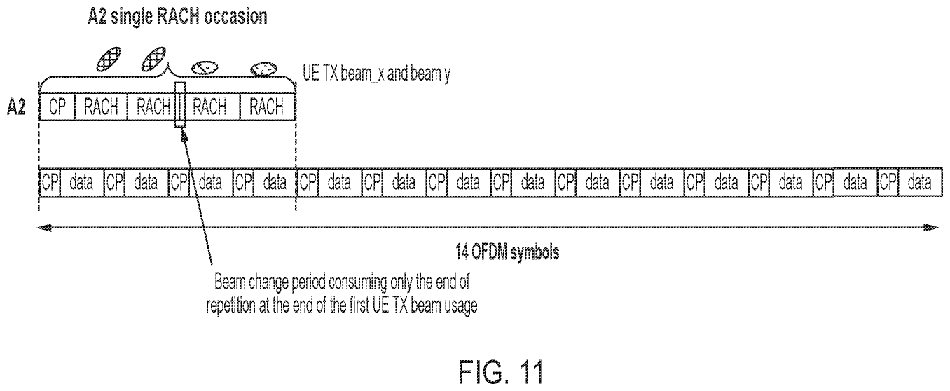

As illustrated in FIG. 11, a UE Tx beam switch during a RO may degrade performance of the PRACH by consuming a certain amount of time, but may not prevent PRACH detection. PRACH signal energy consumed by the UE Tx beam switch may be restored from the CP. In case of PRACH formats including time domain repetition of the original sequence, the end of the repetition may act as a CP for the proceeding repetition.

Beam switching during RACH occasion may degrade the PRACH link budget, but the PRACH signal may still have a good link budget. In return, Msg3 link budget may be improved, which may be the true bottleneck of RA by selection of appropriate UE Tx beam for Msg3, as well as PUCCH with HARQ feedback for Msg4.

At 808, UE 830 may transmit Msg3 to NE 820 using the beam designated at 807 (or indicated at 806). In response, at 809, NE 820 may transmit Msg4 to UE 830. At 810, UE 830 may transmit to NE 820 PUCCH/HARQ for Msg4 using the beam designated at 807 (or indicated at 806).

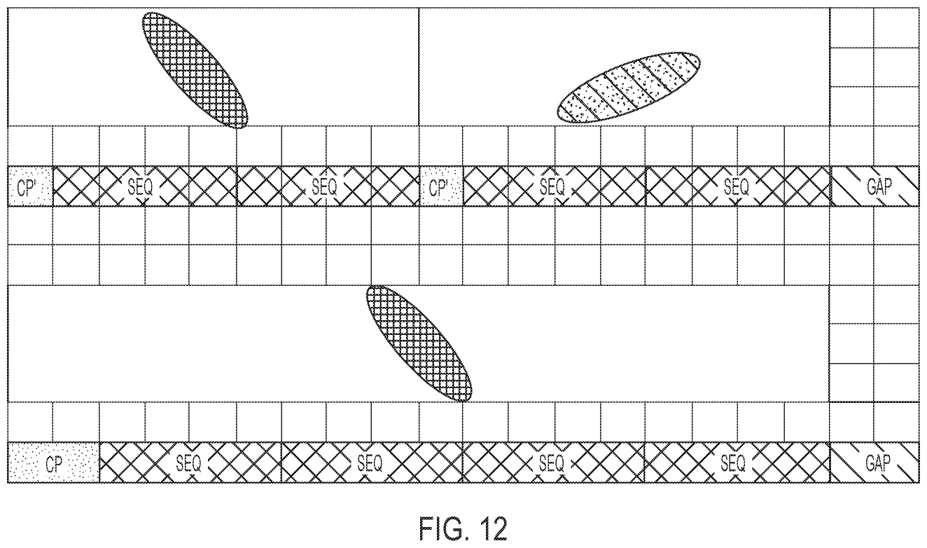

In various example embodiments, the intra-RO beam switch may occur around the border between two repetitions of the RACH sequence in the time domain. However, the exact switching point might continually impact the performance, but as long as the majority of a repetition is transmitted via the intended beam, the scheme can work. The highest performing solution may distribute the original CP equally between each switching point, and the switch may be triggered at the beginning of each new CP. Any transient periods of unstable Tx signal quality may be focused within the new CPs. In addition, the repetitions of the RACH samples may serve as each other's CP, therefore no explicit CP needs to be created and the switching moment in the sample domain creates the CP directly. In this way, the orthogonal frequency division multiplexing (OFDM) modulation may always work (see FIG. 12).

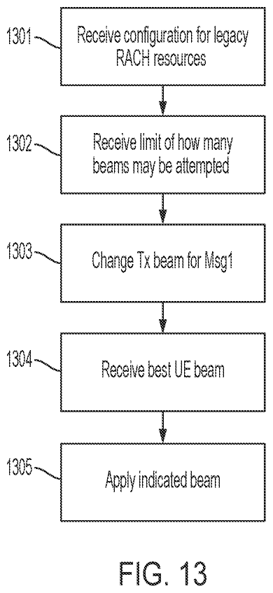

FIG. 13 illustrates an example of a flow diagram of a method that may be performed by a UE, such as UE 2020 illustrated in FIG. 20, according to various example embodiments discussed above. At 1301, the method may include receiving an indication of legacy RACH resources using a format with sequence repetitions, and explicit instructions for a multi-beam Tx UE to perform intra-RO beam changes, such as by SIB. For legacy UEs, RACH may be performed using normal procedures, and the multi-beam (MB) UE configurations may be ignored.

At 1302, the method may include receiving an indication from a BS of a limit on the number of beams that may be attempted, and where the switching points are.

In various example embodiments, the method may include performing multi-beam Tx UE RACH on RO, and changing Tx beams for Msg1 during ROs. In addition, frequency and position of beam changed as determined by the UE, may be based upon a number of beams to try, a Msg1 link budget, and a RACH format.

At 1303, the method may include multi-beam Tx UE RACH on RO, and changing Tx beams for Msg1 during ROs. The frequency and potential positions of beam changes may also be configured by the base station, and Tx beam changes may be filled or skipped. In some example embodiments, the method may include falling back to legacy RACH procedure if no UE beam change has been detected (i.e., legacy UEs may not be compatible with Msg2).

At 1304, the method may include receiving a modified Msg2 indicating Tx switched UE/RAPID about a best UE beam, such as a first or second.

At 1305, the method may include applying the indicated beams to a Msg3 transmission, as well as all further transmissions until legacy beam management is established.

In various example embodiments, the method may include falling back to legacy RA procedure if no UE beam change is detected (e.g., legacy UEs may not be compatible with Msg2).

In certain example embodiments, the UE may apply the indicated beam to Msg3 transmissions, as well as all further transmissions until legacy beam management is established.

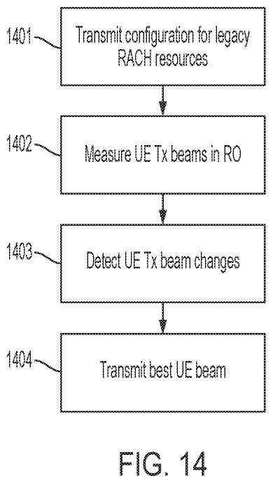

FIG. 14 illustrates an example of a flow diagram of a method that may be performed by a NE, such as NE 2010 illustrated in FIG. 20, according to various example embodiments discussed above. At 1401, the method may include transmitting an indication of legacy RACH resources using a format with sequence repetitions, and explicit instructions for a multi-beam Tx UE to perform intra-RO beam changes, such as by SIB. For legacy UEs, RACH may be performed using normal procedures, and the MB UE configurations may be ignored.

At 1402, the method may include measuring UE Tx beams in RO and determining a best UE RACH beam.

At 1403, the method may include detecting UE Tx beam changes in RO, and determining a best UE RACH beam.

In various example embodiments, the method may include falling back to legacy RA procedure if no UE beam change is detected (e.g., legacy UEs may not be compatible with Msg2).

At 1404, the method may include transmitting a modified Msg2 indicating to a Tx switched UE/RAPID of a best UE beam, such as a first or second.

In certain example embodiments, the UE may apply the indicated beam to Msg3 transmissions, as well as all further transmissions until legacy beam management is established.

In various example embodiments, the method may include receiving, by the network entity, at least one of a message 3 or physical uplink control channel corresponding to message 4 of a random access procedure transmitted by the user equipment using the preferred beam.

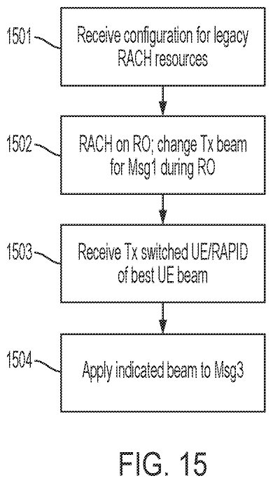

FIG. 15 illustrates an example of a flow diagram of a method that may be performed by a UE, such as UE 2020 illustrated in FIG. 20, according to various example embodiments discussed above. At 1501, the method may include receiving an indication of legacy RACH resources using a format associated with sequence repetitions. For legacy UEs, RACH may be performed using normal procedures.

At 1502, the method may include performing multi-beam Tx UE RACH on RO, and changing Tx beams for Msg1 during ROs. In addition, frequency and position of beam changed as determined by the UE, may be based upon a number of beams to try, a Msg1 link budget, and a RACH format.

In various example embodiments, the method may include falling back to legacy RA procedure if no UE beam change is detected (e.g., legacy UEs may not be compatible with Msg2).

At 1503, the method may include receiving a modified Msg2 indicating to the UE (or RAPID) of which was a best UE beam, such as the first or second.

At 1504, the method may include applying the indicated beam to Msg3 transmissions, as well as all further transmissions until legacy beam management is established.

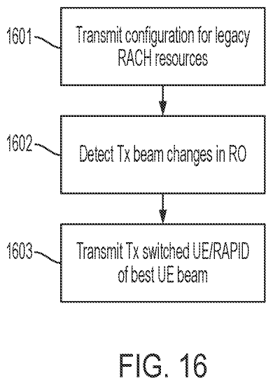

FIG. 16 illustrates an example of a flow diagram of a method that may be performed by a NE, such as NE 2010 illustrated in FIG. 20, according to various example embodiments discussed above. At 1601, the method may include transmitting an indication of legacy RACH resources using a format associated with sequence repetitions. For legacy UEs, RA may be performed using normal procedures.

At 1602, the method may include detecting UE Tx beam changes in RO, and determining the best UE RACH beam. In various example embodiments, the method may include falling back to legacy RA procedure if no UE beam change is detected (e.g., legacy UEs may not be compatible with Msg2).

At 1603, the method may include transmitting a modified Msg2 indicating to the UE (or RAPID) of which was a best UE beam, such as the first or second.

Regarding sequence correlation receivers/detectors, it may not be desirable to correlate all repetitions of received RACH sequence (or samples) with the expected/blindly tested full RACH sequences (or samples), also known as “full coherent combination.”

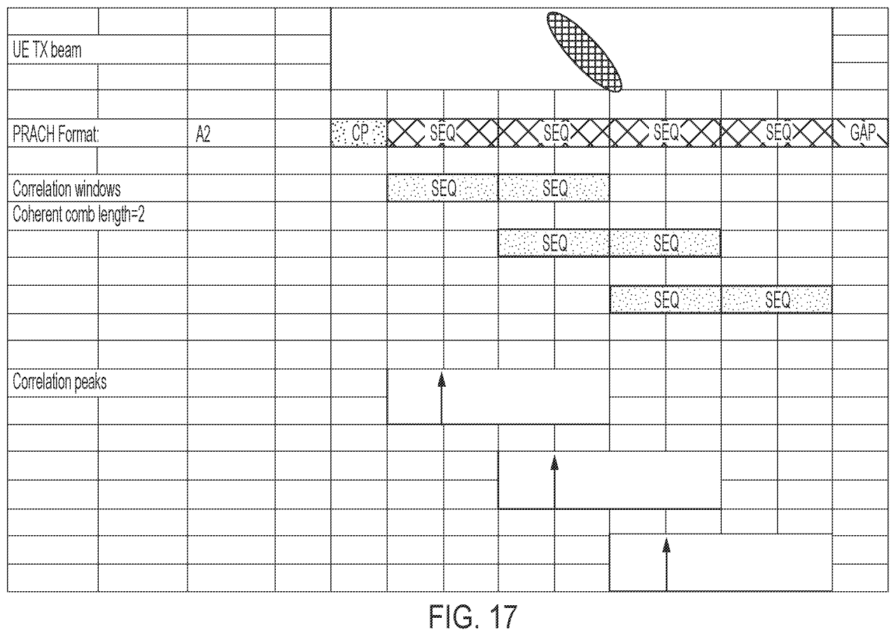

“Coherent combination lengths” may refer to between 2 and 6 sequence repetitions, and a sliding window of this “coherent combination length” may be used over the received sequence/samples to detect correlation peaks with, for example, 2 sequence repetitions, and then non-coherently combine (e.g., weighted sum) those peaks, after re-centering each detected peak in the expected correlation sample position for the chosen cyclic shift (assuming there is no frequency offset or other imperfection), as illustrated in FIG. 17. As shown, the UE is not changing Tx beam during the RO/RACH format, hence in perfect conditions the peaks are all the same in height and position.

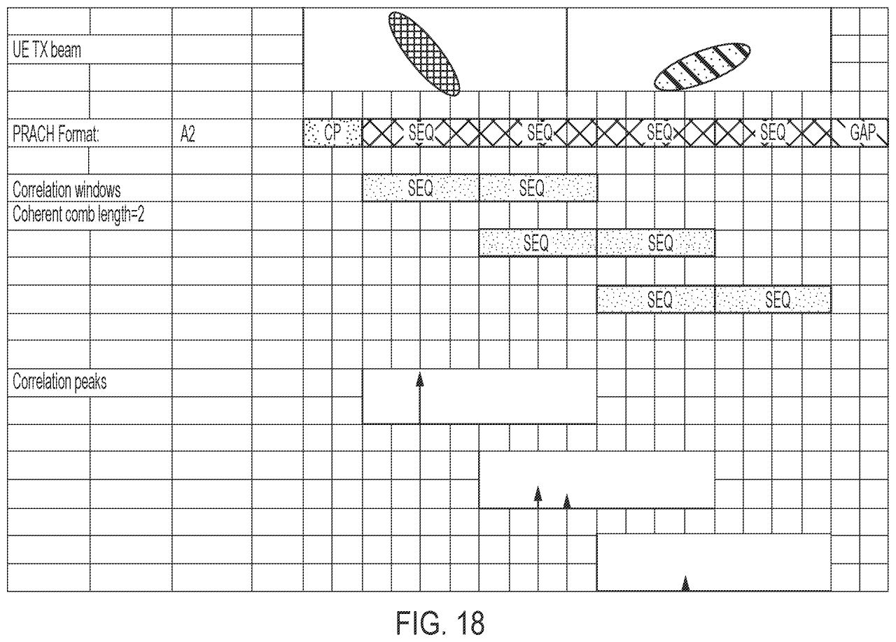

FIG. 18 depicts the change in receive signal power due a UE changing its transmission beam will impact the peaks/values observed in the correlation receiver, depending on whether the chosen UE Tx beam improves the reception or not, i.e., the gain achieved by the chosen beam. The UE is shown as changing Tx beam during the RO/RACH format. Even in perfect channel conditions, the peak height depends on signal gain of Tx beam/path, and the peak position changes depending on propagation time differences between Tx beams.

Furthermore, different beams will have different propagation paths and distances, hence even the relative position of the correlation peaks in the correlation samples changes. Both the correlation peak value and position in all the correlation windows may consequently be used to detect the usage of Tx beam changes on the UE side. Furthermore, the beam change timing, number of beams, and best beam (according to selectable criteria) can be detected.

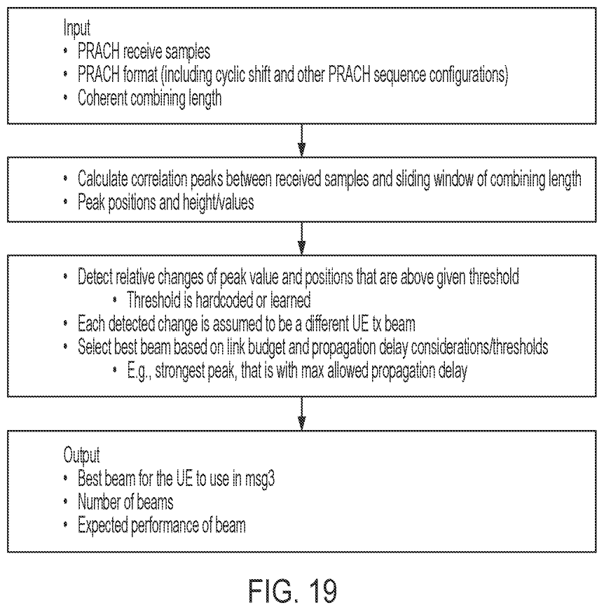

FIG. 19 illustrates an example implementation of a simple “best beam” selector based on or reutilizing the coherent combination length correlation detector implementation, and using relative changes of peak value and positions to detect beam changes.

FIG. 20 illustrates an example of a system according to certain example embodiments. In one example embodiment, a system may include multiple devices, such as, for example, NE 2010 and/or UE 2020.

NE 2010 may be one or more of a base station, such as an eNB or gNB, a serving gateway, a server, and/or any other access node or combination thereof.

NE 2010 may further comprise at least one gNB-CU, which may be associated with at least one gNB-DU. The at least one gNB-CU and the at least one gNB-DU may be in communication via at least one F1 interface, at least one Xₙ₋C interface, and/or at least one NG interface via a fifth generation core (5GC).

UE 2020 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 2010 and/or UE 2020 may be one or more of a citizens broadband radio service device (CBSD).

NE 2010 and/or UE 2020 may include at least one processor, respectively indicated as 2011 and 2021. Processors 2011 and 2021 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 2012 and 2022. The memory may be fixed or removable. The memory may include computer program instructions or computer code contained therein. Memories 2012 and 2022 may independently be any suitable storage device, such as a non-transitory computer-readable medium. The term “non-transitory,” as used herein, is a limitation of the medium itself (i.e., tangible, not a signal) as opposed to a limitation on data storage persistency (e.g., RAM vs. ROM). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 2011 and 2021, memories 2012 and 2022, and any subset thereof, may be configured to provide means corresponding to the various blocks of FIGS. 1-20. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 20, transceivers 2013 and 2023 may be provided, and one or more devices may also include at least one antenna, respectively illustrated as 2014 and 2024. The device may have many antennas, such as an array of antennas configured for multiple input multiple output (MIMO) communications, or multiple antennas for multiple RATs. Other configurations of these devices, for example, may be provided. Transceivers 2013 and 2023 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 1-20). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 1-20. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

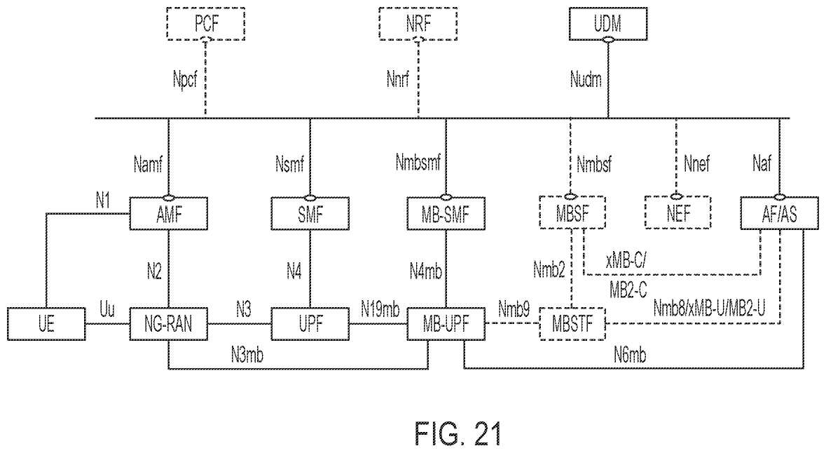

FIG. 21 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 21 may be similar to NE 2010 and UE 2020, respectively. The user plane function may provide services such as intra-RAT and inter-RAT mobility, routing and forwarding of data packets, inspection of packets, user plane quality of service processing, buffering of downlink packets, and/or triggering of downlink data notifications. The application function (AF) may primarily interface with the core network to facilitate application usage of traffic routing and interact with the policy framework.

According to certain example embodiments, processors 2011 and 2021, and memories 2012 and 2022, may be included in or may form a part of processing circuitry or control circuitry. In addition, in some example embodiments, transceivers 2013 and 2023 may be included in or may form a part of transceiving circuitry.

In some example embodiments, an apparatus (e.g., NE 2010 and/or UE 2020) may include means for performing a method, a process, or any of the variants discussed herein. Examples of the means may include one or more processors, memory, controllers, transmitters, receivers, and/or computer program code for causing the performance of the operations.

In various example embodiments, apparatus 2010 may be controlled by memory 2012 and processor 2011 to receive a physical random access channel preamble based upon at least two different transmission beams in the same random access channel occasion from the same user equipment, detect a transmission beam switching operation of the user equipment, and transmit a message configured to indicate a preferred transmission beam of the transmission beams used with the physical random access channel preamble.

Certain example embodiments may be directed to an apparatus that includes means for performing any of the methods described herein including, for example, means for receiving a physical random access channel preamble based upon at least two different transmission beams in the same random access channel occasion from the same user equipment, means for detecting a transmission beam switching operation of the user equipment, and means for transmitting a message configured to indicate a preferred transmission beam of the transmission beams used with the physical random access channel preamble.

In various example embodiments, apparatus 2020 may be controlled by memory 2022 and processor 2021 to transmit a physical random access channel preamble based upon at least two different transmission beams in the same random access channel occasion, and receive a message configured to indicate a preferred transmission beam of the transmission beams used with the physical random access channel preamble.

Certain example embodiments may be directed to an apparatus that includes means for performing any of the methods described herein including, for example, means for transmitting a physical random access channel preamble based upon at least two different transmission beams in the same random access channel occasion, and means for receiving a message configured to indicate a preferred transmission beam of the transmission beams used with the physical random access channel preamble.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

3GPP Third Generation Partnership Project
5G Fifth Generation
5GC Fifth Generation Core
6G Sixth Generation
AMF Access and Mobility Management Function
ASIC Application Specific Integrated Circuit
BS Base Station
CBRA Contention Based Random Access
CBSD Citizens Broadband Radio Service Device
CE Control Element
CN Core Network
CP Cyclic Prefix
CPU Central Processing Unit
CRC Cyclic Redundancy Check
C-RNTI Cell Radio Network Temporary Identifier
CU Centralized Unit
DCI Downlink Control Information
DL Downlink
eMBB Enhanced Mobile Broadband
eMTC Enhanced Machine Type Communication
eNB Evolved Node B
FDM Frequency Domain Multiplexing
FR Frequency Range
gNB Next Generation Node B
GPS Global Positioning System
HARQ Hybrid Automatic Repeat Request
HDD Hard Disk Drive
IoT Internet of Things
KPI Key Performance Indicator
LTE Long-Term Evolution
LTE-A Long-Term Evolution Advanced
MAC Medium Access Control
MCS Modulation and Coding Scheme
MEMS Micro Electrical Mechanical System
MIB Master Information Block
MIMO Multiple Input Multiple Output
mMTC Massive Machine Type Communication
mmW Millimeter Wave
Msg Message
NB-IoT Narrowband Internet of Things
NE Network Entity
NG Next Generation
NG-eNB Next Generation Evolved Node B
NG-RAN Next Generation Radio Access Network
NR New Radio
NR-U New Radio Unlicensed
OFDM Orthogonal Frequency Division Multiplexing
PDA Personal Digital Assistance
PDCCH Physical Downlink Control Channel
PDU Protocol Data Unit
PRACH Physical Random Access Channel
PUCCH Physical Uplink Control Channel
PUSCH Physical Uplink Shared Channel
RA Random Access
RACH Random Access Channel
RAM Random Access Memory
RAN Radio Access Network
RAPID Random Access Preamble Identifier
RAR Random Access Response
RAT Radio Access Technology
RE Resource Element
RF Radio Frequency
RNTI Radio Network Temporary Identifier
RO Random Access Channel Occasion
RRC Radio Resource Control
RS Reference Signal
RSRP Reference Signal Received Power
Rx Receive
SEQ Sequence
SI System Information
SINR Signal to Interference & Noise Ratio
SIB System Information Block
SMF Session Management Function
SSB Synchronization Signal Block
TA Timing Advance
TB Transport Block
TBS Transport Block Size
TDRA Time Domain Resource Allocation
Tx Transmission
UE User Equipment
UL Uplink
URLLC Ultra-Reliable and Low-Latency Communication
UTRAN Universal Mobile Telecommunications System Terrestrial Radio Access Network
WLAN Wireless Local Area Network

1. An apparatus comprising:
at least one processor; and
at least one memory storing instructions that, when executed by the at least one processor, cause the apparatus at least to:
transmit a physical random access channel preamble based upon at least two different transmission beams in the same random access channel occasion; and
receive a message configured to indicate a preferred transmission beam of the transmission beams used with the physical random access channel preamble.

2. The apparatus of claim 1, wherein the at least one memory and instructions, when executed by the at least one processor, further cause the apparatus at least to:
receive information that enables the transmission of the physical random access channel preamble using the at least two different transmission beams.

3. The apparatus of claim 1, wherein the at least one memory and instructions, when executed by the at least one processor, further cause the apparatus at least to:
receive a beam-change mapping as part of system information configured to control the beam switching points at the apparatus for transmitting the physical random access channel preamble using the at least two different transmission beams.

4. The apparatus of claim 1, wherein the message indicating the preferred transmission beam is received via at least one of: a medium access control control element, downlink control information, or physical downlink control channel signaling.

5. The apparatus of claim 1, wherein the at least one memory and instructions, when executed by the at least one processor, further cause the apparatus at least to:
select transmission beams spatially matched to reception beams that measure above a synchronization signal block power threshold for a synchronization signal block beam.

6. The apparatus of claim 1, wherein the at least one memory and instructions, when executed by the at least one processor, further cause the apparatus at least to:
transmit at least one of a message 3 or physical uplink control channel corresponding to message 4 of a random access procedure using the preferred transmission beam.

7. An apparatus comprising:
at least one processor; and
at least one memory storing instructions that, when executed by the at least one processor, cause the apparatus at least to:
receive a physical random access channel preamble based upon at least two different transmission beams in the same random access channel occasion from the same user equipment;
detect a transmission beam switching operation of the user equipment; and
transmit a message configured to indicate a preferred transmission beam of the transmission beams used with the physical random access channel preamble.

8. The apparatus of claim 7, wherein the at least one memory and instructions, when executed by the at least one processor, further cause the apparatus at least to:
transmit information prior to receiving the physical random access channel preamble that enables the transmission of the physical random access channel preamble using the at least two different transmission beams.

9. The apparatus of claim 7, wherein the at least one memory and instructions, when executed by the at least one processor, further cause the apparatus at least to:
detect within a single random access channel occasion a user equipment transmission beam to indicate in the message configured to indicate the preferred transmission beam.

10. The apparatus of claim 7, wherein the at least one memory and instructions, when executed by the at least one processor, further cause the apparatus at least to:
transmit a beam-change mapping as part of system information configured to control the beam switching points at the user equipment for transmitting the physical random access channel preamble using the at least two different transmission beams.

11. The apparatus of claim 7, wherein the at least one memory and instructions, when executed by the at least one processor, further cause the apparatus at least to:
transmit the message indicating the preferred transmission beam via at least one of: a medium access control control element, downlink control information, or physical downlink control channel signaling.

12. The apparatus of claim 7, wherein the at least one memory and instructions, when executed by the at least one processor, further cause the apparatus at least to:
receive at least one of a message 3 or physical uplink control channel corresponding to message 4 of a random access procedure transmitted by the user equipment using the preferred beam.

13. A method comprising:
transmitting, by a user equipment, a physical random access channel preamble based upon at least two different transmission beams in the same random access channel occasion; and
receiving, by the user equipment, a message configured to indicate a preferred transmission beam of the transmission beams used with the physical random access channel preamble.

14. The method of claim 13, further comprising:
receiving, by the user equipment, information that enables the transmission of the physical random access channel preamble using the at least two different transmission beams.

15. The method of claim 13, further comprising:
receiving, by the user equipment, a beam-change mapping as part of system information configured to control the beam switching points at the user equipment for transmitting the physical random access channel preamble using the at least two different transmission beams.

16. The method of claim 13, wherein the message indicating the preferred transmission beam is received via at least one of: a medium access control control element, downlink control information, or physical downlink control channel signaling.

17.-18. (canceled)

19. A method comprising:
receiving, by a network entity, a physical random access channel preamble based upon at least two different transmission beams in the same random access channel occasion from the same user equipment;
detecting, by the network entity, a transmission beam switching operation of the user equipment; and
transmitting, by the network entity, a message configured to indicate a preferred transmission beam of the transmission beams used with the physical random access channel preamble.

20. The method of claim 19, further comprising:
transmitting, by the network entity, information prior to receiving the physical random access channel preamble that enables the transmission of the physical random access channel preamble using the at least two different transmission beams.

21. The method of claim 19, further comprising:
detecting, by the network entity, within a single random access channel occasion a user equipment transmission beam to indicate in the message configured to indicate the preferred transmission beam.

22. The method of claim 19, further comprising:
transmitting, by the network entity, a beam-change mapping as part of system information configured to control the beam switching points at the user equipment for transmitting the physical random access channel preamble using the at least two different transmission beams.

23.-25. (canceled)
